(19) United States
(12) Patent Application Publication
(10) Pub. No.: US 2025/0078045 A1
(43) Pub. Date: Mar. 6, 2025

(54) METHOD AND MANAGING MODULE FOR MANAGING AN ESCROW PAYMENT SERVICE

(71) Applicant: BCV I ROBERTSFORS AB, Stockholm (SE)

(72) Inventors: Anders JONSON, Stockholm (SE); Riccardo PENZO, Stockholm (SE); Erik AHRSJÖ, Stockholm (SE)

(21) Appl. No.: 18/571,008

(22) PCT Filed: Jun. 18, 2021
(86) PCT No.: PCT/SE2021/050607

§ 371 Date: Dec. 15, 2023

(51) Int. Cl. G06Q 20/02; G06Q 20/40

(52) U.S. Cl. CPC G06Q 20/02; G06Q 20/401; G06Q 2220/00

(57) ABSTRACT

A method and a managing module “MM” (110) for managing an escrow payment service for purchases in a store of a vendor. The MM (110) receives purchase information comprising an identity of the vendor, an identity of a customer, a price, an offer specification and a condition. The MM (110) stores the identity of the vendor, the identity of the customer, the price and the offer specification. The MM (110) stores the respective number of the vendor and the customer and the condition in a smart contract on a blockchain (130). The MM (110) sends a request for acceptance of the smart contract and receives a response for accepting the smart contract. The MM (110) sets a state of the smart contract to accepted. The MM (110) sends a transaction request. The MM (110) stores the transaction identity in the smart contract. The MM (110) receives a transaction response indicating that the temporary credit card holds the funds corresponding to the price. The MM (110) stores, in the smart contract, an indication of that the transaction is completed. The MM (110) sends, to the server (111) and the user device (120), a notification confirming successful payment and login details for access to list of transactions of the smart contracts smart contract. The MM (110) checks the conditions of the smart contract to obtain an answer indicating fulfilment or non-fulfilment of the conditions. The MM (110) sets the state of the smart contract to completed or rejected. A corresponding computer program (403) and a computer program carrier (405) are also disclosed.

### TECHNICAL FIELD

Embodiments herein relate to systems for payment solutions, such as payment solutions for trips, i.e. travelling for business or personal purposes. In particular, a method and a managing module for managing an escrow payment service for purchases in a store of a vendor are disclosed. A corresponding computer program and a computer program carrier are also disclosed.

### BACKGROUND

Typically, payment solutions for travelling include payment by a credit card. This is often convenient, since it is a well-established method of payment which both travellers and companies providing the travels are familiar with and trust.

Unlike a more direct purchase, such as a purchase of clothes in a physical store, purchases of travels often include a guarantee of refund, e.g. in case the trip is not performed as scheduled. The guarantee may be provided in many different forms, but do not always provided a full refund. Moreover, the travels must often navigate through a refunding procedure, which can be both complex, cumbersome and time consuming. Should the travel complete the refunding procedure, which in itself consumes a lot of time and effort, there will still be an additional waiting period for the traveller before the refund appears on the traveller's bank account. Therefore, it is common that many travellers hesitate to buy a trip, due to that the refund procedure is such a hazzle. Furthermore, many travellers therefore find it difficult to trust that the guarantee will be fulfilled.

The same or similar hesitation and/or trust issue may also occur for customers in many other businesses, i.e. not only travel business. For example, this problem may occur in online shopping scenarios for most consumer products and/or services.

Accordingly, a problem related to payments solutions for e.g. travels concerns trust and how to perform refunds.

### SUMMARY

An object may be to eliminate, or at least reduce, one or more the abovementioned disadvantages and/or problems.

According to an aspect, the object is achieved by a method according to claim 1. Thus, the object is achieved by a method, performed by a managing module, for managing an escrow payment service for purchases in a store of a vendor. The managing module receives, directly or indirectly from a server, purchase information comprising an identity of the vendor, an identity of a customer, a price, an offer specification and a condition for triggering of transaction advancement. The managing module stores the identity of the vendor, the identity of the customer, the price and the offer specification in a database. The identity of the vendor and the identity of the customer are associated with a respective number for anonymizing the vendor and the customer. The managing module stores the respective number of the vendor and the customer and the condition in a smart contract on a blockchain. The managing module sends a request for acceptance of the smart contract to the user device of the customer. The managing module receives, from the user device, a response for accepting the smart contract. The response comprises payment information for withdrawing the price from assets of the customer. The managing module sets a state of the smart contract to accepted. The managing module sends, to a payment service provider, a transaction request comprising the payment information for ordering a transaction for transfer of funds corresponding to the price to a temporary credit card. The transaction is identified by a transaction identity. The managing module stores the transaction identity in the smart contract. The managing module receives a transaction response indicating that the temporary credit card holds the funds corresponding to the price. The managing module stores, in the smart contract, an indication of that the transaction according to the transaction identity is completed. The managing module sends, to the server and the user device, a notification confirming successful payment and login details for access to list of transactions of the smart contract. The managing module checks the conditions of the smart contract to obtain an answer indicating fulfilment or non-fulfilment of the conditions. The managing module sets the state of the smart contract to completed or rejected based on the answer, thereby causing the payment to be transferred to the vendor and/or the customer, respectively.

According to another aspect, the object is achieved by a managing module according to claim 2.

Thus, the object is achieved by a managing module configured for managing an escrow payment service for purchases in a store of a vendor. The managing module is configured for receiving, directly or indirectly from a server, purchase information comprising an identity of the vendor, an identity of a customer, a price, an offer specification and a condition for triggering of transaction advancement. The managing module is configured for storing the identity of the vendor, the identity of the customer, the price and the offer specification in a database. The identity of the vendor and the identity of the customer are associated with a respective number for anonymizing the vendor and the customer. The managing module is configured for storing the respective number of the vendor and the customer and the condition in a smart contract on a blockchain. The managing module is configured for sending a request for acceptance of the smart contract to the user device of the customer. The managing module is configured for receiving, from the user device, a response for accepting the smart contract. The response comprises payment information for withdrawing the price from assets of the customer. The managing module is configured for setting a state of the smart contract to accepted. The managing module is configured for sending, to a payment service provider, a transaction request comprising the payment information for ordering a transaction for transfer of funds corresponding to the price to a temporary credit card. The transaction is identified by a transaction identity. The managing module is configured for storing the transaction identity in the smart contract. The managing module is configured for receiving a transaction response indicating that the temporary credit card holds the funds corresponding to the price. The managing module is configured for storing, in the smart contract, an indication of that the transaction according to the transaction identity is completed. The managing module is configured for sending, to the server and the user device, a notification confirming successful payment and login details for access to list of transactions of the smart contract. The managing module is configured for checking the conditions of the smart contract to obtain an answer indicating fulfilment or non-fulfilment of the conditions. The managing module is configured for setting the state of the smart contract to completed or rejected based on the answer, thereby causing the payment to be transferred to the vendor and/or the customer, respectively.

According to further aspects, the object is achieved by a computer program and a computer program carrier corresponding to the aspects above.

Many transactions today put the merchant in an advantageous position where the risk lies on the customer, making the payment before receiving the product and/or the service. There are solutions where you can pay upon delivery, however—those solutions are on the terms on the merchant dictating those terms, not the consumer. Making chargebacks or refund is a lengthy and complicated process by design to discourage consumers.

By introducing an independent third party, represented by the management module that manages safekeeping of the payment, the risk and liability of the involved parties are on equal terms, where both will receive payment when the product and/or the service is delivered. Apart from the technological innovations involved in this sequence of actions, such as the use of a non-disputable blockchain with smart contracts and an EMI (Electronic Money Institution), an advantage of the embodiments herein is the perception of business on equal terms.

Business transaction equality is a sought-after functionality in many businesses, such as e-merchants, various person-to-person online marketplaces and the travel industry, to mention a few.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1 is a schematic overview of an exemplifying system in which embodiments herein may be implemented.

FIG. 2 is a combined signalling and flowchart illustrating the methods herein.

FIG. 3 is a flowchart illustrating embodiments of the method in the managing module.

FIG. 4 is a block diagram illustrating embodiments of the managing module.

### DETAILED DESCRIPTION

Throughout the following description, similar reference numerals have been used to denote similar features, such as nodes, actions, modules, circuits, parts, items, elements, units or the like, when applicable. In the Figures, features that appear in some embodiments are indicated by dashed lines.

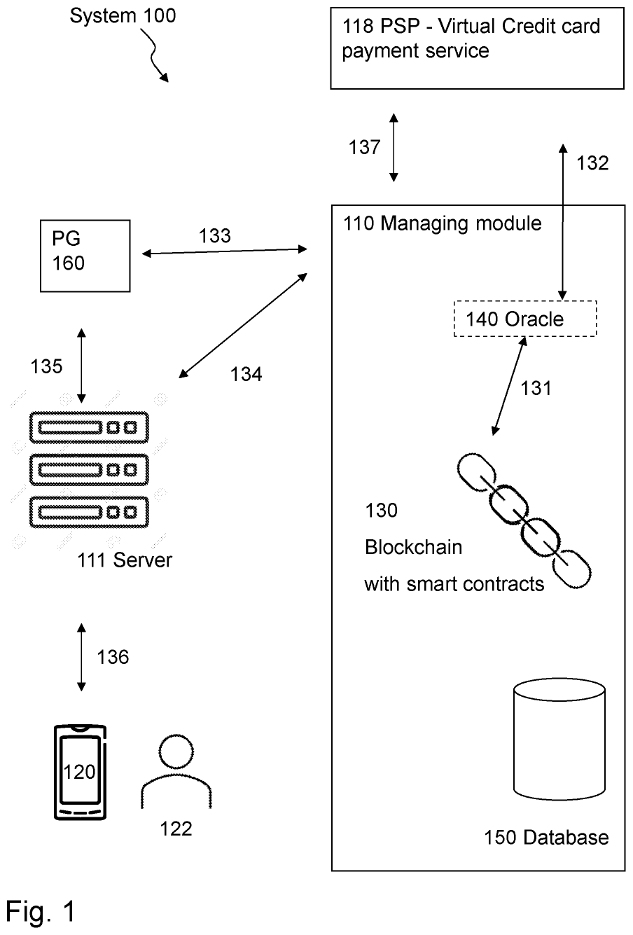

FIG. 1 depicts an exemplifying system 100 in which embodiments herein may be implemented. The system 100 may comprise any known communication network and/or protocols using a wired and/or wireless technologies, e.g. for short and/or long range communication.

The system 100 comprises a managing module 110 for managing an escrow payment service. An escrow payment service means that a seller and a buyer has agreed to allow a third party to hold funds, typically money, for a purchase that the buyer has effected in the sellers store, such as a virtual or physical store. The seller receives the funds only when the buyer has received and accepted the purchase, such as a product, a service or the like. However, the seller knows that the buyer will be able to pay, since the funds are held by the third party. The seller risk of delivering a product/service and not get paid is thus vastly reduced, or even eliminated.

The managing module 110 further manages a blockchain 130 for smart contracts. The blockchain 130 may be any commercially available blockchain for smart contracts.

Moreover, the managing module 110 may comprise an oracle module 140, which operates as an interface between the blockchain 130 and external sources and/or external targets. Thus, the oracle module 140, or oracle for short, may send and receive 132 information to/from the blockchain 130 to the external sources and/or external targets. An external source may e.g. provide information about completed trips and an external target may allow a smart contract on the blockchain 130 to trigger a payment, or a transaction of funds. For example, the oracle module 140 may provide external information to the smart contract based on which the smart contract may trigger events, or transactions. Commands for the events or transactions may be sent back to the oracle module 140 in case the events or transactions to be performed are external to the blockchain 130. Depending on implementation, the oracle module 140 may also reside outside the managing module 110.

The system 100 further comprises a payment service provider (PSP) 118, such as a virtual credit card payment service. The managing module 110 may send 137 requests to the PSP 118 for execution of payments to the vendor and/or the customer 122. The PSP 118 may act as a so called EMI, thereby ensuring that money held by it are not exposed to financial risk due to investment of the money. In this manner, the PSP 118 acts as the third party holding the funds.

The managing module 110 may further have access, e.g. for read and write purposed, to a database 150. The database 150 may be comprised in the managing module 110 (as shown) or it may be external to the managing module 110 (not shown).

FIG. 1 also illustrates a server 111, such as a web server or the like. The server 111 may host a virtual store, such as a web shop or the like. The server 111 thus provides for the possibility for customers to perform purchases of e.g. products, services or the like, from a vendor. The server 111 is thus associated with a vendor that sells products, services or the like, in the virtual store.

A customer 122 uses a user device 120, such as a smartphone, a computer, a tablet, or the like, to access the virtual store to buy the products and/or services from the virtual store.

When purchasing an item, such as a product and/or service, the customer 122 selects a payment method, e.g. as a part of a checkout procedure or in a payment gateway. If the customer 122 selects an escrow payment service according to the embodiments herein, payment information is provided to the managing module 110 and further actions follow as described herein. Optionally, the customer 122 selects any other known payment method, which may be provided by the payment gateway. Sometimes, the virtual store, or the server 111, may invoke the payment gateway, which in turn allow the customer 122 to select payment method, such as by credit card, invoice, and also the escrow payment service as described herein. Accordingly, the payment information may reach the managing module 110 by direct communication 134 with the server 111, or by indirect communication 133, 135 via the payment gateway 160.

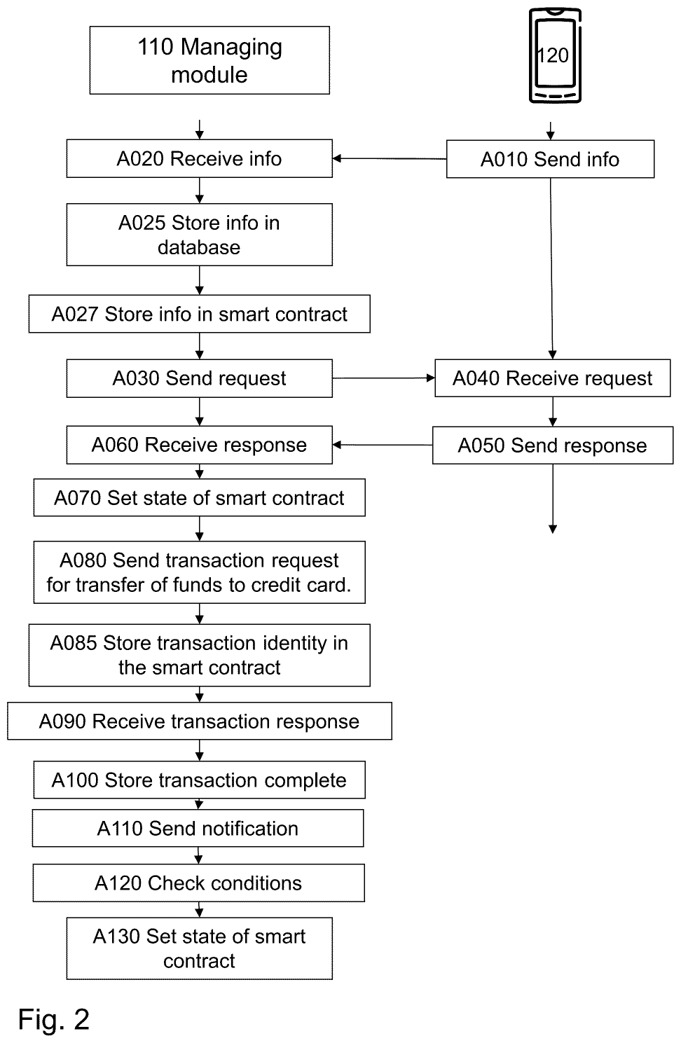

FIG. 2 illustrates an exemplifying method according to the embodiments herein when implemented in the system 100 of FIG. 1. The managing module 110 performs a method for managing an escrow payment service.

Prior to action A010 below, a customer, such as a user of the user device 120, visits a virtual store hosted on the server 111.

In one example, the customer 122 selects a trip to a wonderful place. In the check-out of the virtual store, the customer 122 selects to pay using the escrow payment service provided by the managing module 110 as described herein.

One or more of the following actions may be performed in any suitable order.

### Action A010

Subsequently to the selection of the escrow payment service, the server 111 sends 133, 134, 135, to the managing module 110, purchase information relating to a purchase, such as the trip to the wonderful place according to said one example mentioned above.

The purchase information comprises an identity of vendor, an identity of customer, a price, an offer specification and a condition for triggering of transaction advancement, e.g. a condition that determines when the payment for the purchase shall be transferred completely or in part to the vendor and/or the customer.

As an example, the identity of the vendor may comprise one or more of a name of the vendor, a tax registration number of the vendor, an address of the vendor or the like.

As an example, the identity of the customer 122 may comprise one or more of a name of the customer, a personal security number of the customer, an address of the customer 122 or the like.

The price is typically expressed as an amount in a currency, such as USD, SEK, a cryptocurrency, or the like.

The offer specification related to the product and/or service purchased by the customer. The offer specification may comprise article number(s), number of entities, etc. With said one example, the offer specification may comprise one or more of a flight number, a destination, arrival time and date, departure time and date, carrier, etc.

Furthermore, the condition for triggering of transaction advancement is fulfilled relates to one or more of when, why and under what circumstances the purchase is considered to be completed or rejected.

### Action A020

Subsequently to action A010, the managing module 110 receives, directly or indirectly from the server 111, the purchase information.

### Action A025

The managing module 110 stores the identity of the vendor, the identity of the customer, the price and the offer specification in a database 150. The identity of the vendor and the identity of the customer 122 are associated with a respective number for anonymizing the vendor and the customer.

Should the identity of the vendor and/or the identity of the customer 122, it would not be possible to delete this information. The respective numbers are instead used to map the identities to anonymized numbers, which may remain in the blockchain 130 indefinitely, but when the mapping to the identity of the vendor/customer is deleted, these number lose their meaning. Thus, allowing integrity of the customer to be ensured.

### Action A027

The managing module 110 stores the respective number of the vendor and the customer 122 and the condition in a smart contract on a blockchain 130, typically a private block chain. The blockchain 130 can only be written at by the managing module 110, but other entities, such as the server 111, the user device 120 or the like, may read information from the blockchain 130.

In more detail, this means that the smart contract is used for setting up the conditions for each agreement between the customer 122 and the vendor. Accordingly, there will be a new block on the blockchain 130 that holds one or more such agreements.

### Action A030

The managing module 110 sends a request for acceptance of the smart contract to the user device 120 of the customer 122.

### Action A040

Subsequently to action A030, the user device 120 receives the request and displays at least some of the purchase information and at least some portions of the condition to the customer 122. The customer 122 may then interact with the user device 120 using any known method, such as mouse, keyboard, touchscreen or the like, to accept the condition and the purchase information.

### Action A050

Then, e.g. in response to the acceptance of the condition and the purchase information, the user device 120 sends a response to the managing module 110.

### Action A060

Subsequently to action A050, the managing module 110 receives, from the user device 120, the response for accepting the smart contract. The response comprises payment information for withdrawing the price from assets of the customer, e.g. at a bank account, a credit card or the like.

### Action A070

Now that the customer has accepted the condition for the purchase, the managing module 110 sets a state of the smart contract to accepted. Action A070 may be performed before action A080 below.

### Action A080

The managing module 110 sends, to the payment service provider 118, a transaction request comprising the payment information for ordering a transaction for transfer of funds corresponding to the price to a temporary credit card, e.g. own by a legal entity responsible for the manging module 110. The transaction is identified by a transaction identity.

### Action A085

The managing module 110 stores the transaction identity in the smart contract.

### Action A090

The managing module 110 receives a transaction response indicating that the temporary credit card holds the funds corresponding to the price.

### Action A100

The managing module 110 stores, in the smart contract, an indication of that the transaction according to the transaction identity is completed.

In this manner, the vendor may access the blockchain 130 and monitor whether the funds for financing the purchase are secured by the managing module 110 or not. Thus, when the funds are secured, the vendor can safely, e.g. without risk or small risk, deliver the product and/or service for the customer's 122 consumption.

### Action A110

The managing module 110 sends, to the server 111 and the user device 120, a notification confirming successful payment and login details for access to blockchain 130 comprising the smart contract. In more detail, the blockchain 130 holds transactions relating to the contract, such as funds frozen, contract accepted/rejected/completed, etc. reflecting one or more the state, event(s) and information for the smart contract.

### Action A120

The managing module 110 checks the conditions of the smart contract to obtain an answer indicating fulfilment or non-fulfilment of the conditions. This action may be triggered by the oracle module. Alternatively or additionally, this action may be performed regularly or irregularly.

### Action A130

Subsequent to action A120, the managing module 110 sets the state of the smart contract to completed or rejected based on the answer, thereby causing the payment to be transferred to the vendor and/or the customer, respectively.

This means that the change of the state of the smart contract will trigger execution of code in the smart contract that will, e.g. via the managing module 110 and/or the oracle module 140, send a command to the third party, such as the PSP 118, that holds the funds for the purchase.

The command will instruct the third party to transfer the payment to the vendor if the purchase was completed or to the customer if the purchase was rejected, or failed. Depending on the conditions, a portion of the payment will be transferred to the vendor and another portion will be transferred to the customer 122.

With said one example, the conditions may for example specify that there will be a 10% refund if the arrival time, or the departure time, is delayed, e.g. between 1 hour and 3 hours. Other refund portions, such as 15%, 25% etc., may apply according to various selectable conditions.

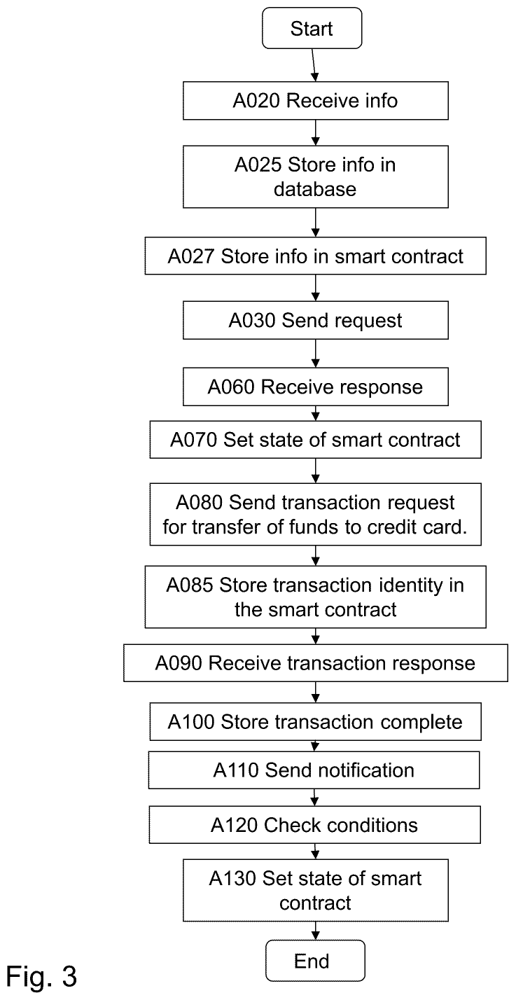

In FIG. 3, a schematic flowchart of exemplifying method in the managing module 110 is shown. Again, the same reference numerals as above have been used to denote the same or similar features, in particular the same reference numerals have been used to denote the same or similar actions. Accordingly, the managing module 110 performs a method for managing an escrow payment service for purchases in a store of a vendor.

One or more of the following actions may be performed in any suitable order.

### Action A020

The managing module 110 receives, directly or indirectly from a server 111, purchase information comprising an identity of the vendor, an identity of a customer, a price, an offer specification and a condition for triggering of transaction advancement.

### Action A025

The managing module 110 stores the identity of the vendor, the identity of the customer, the price and the offer specification in a database 150. The identity of the vendor and the identity of the customer are associated with a respective number for anonymizing the vendor and the customer.

### Action A027

The managing module 110 stores the respective number of the vendor and the customer and the condition in a smart contract on a blockchain 130.

### Action A030

The managing module 110 sends a request for acceptance of the smart contract to the user device 120 of the customer.

### Action A060

The managing module 110 receives, from the user device 120, a response for accepting the smart contract. The response comprises payment information for withdrawing the price from assets of the customer.

### Action A070

The managing module 110 sets a state of the smart contract to accepted.

### Action A080

The managing module 110 sends, to a payment service provider 118, a transaction request comprising the payment information for ordering a transaction for transfer of funds corresponding to the price to a temporary credit card. The transaction is identified by a transaction identity.

### Action A085

The managing module 110 stores the transaction identity in the smart contract.

### Action A090

The managing module 110 receives a transaction response indicating that the temporary credit card holds the funds corresponding to the price.

### Action A100

The managing module 110 stores, in the smart contract, an indication of that the transaction according to the transaction identity is completed.

### Action A110

The managing module 110 sends, to the server 111 and the user device 120, a notification confirming successful payment and login details for access to list of transactions of the smart contract.

### Action A120

The managing module 110 checks the conditions of the smart contract to obtain an answer indicating fulfilment or non-fulfilment of the conditions.

### Action A130

The managing module 110 sets the state of the smart contract to completed or rejected based on the answer, thereby causing the payment to be transferred to the vendor and/or the customer, respectively.

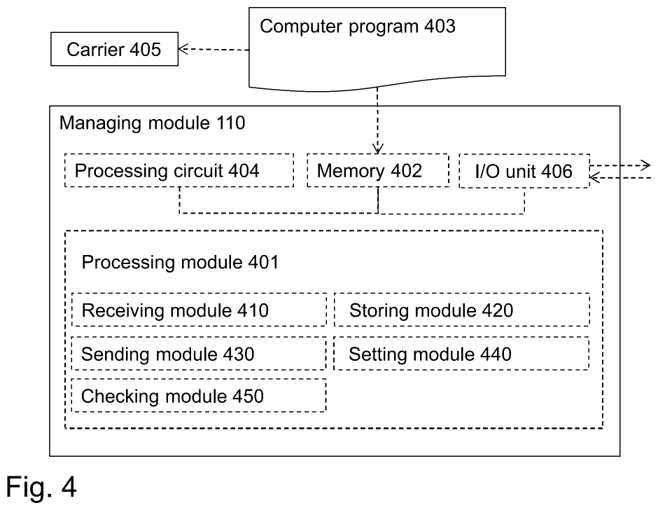

With reference to FIG. 4, a schematic block diagram of embodiments of the managing module 110 of FIG. 1 is shown.

The managing module 110 may comprise a processing module 401, such as a means for performing the methods described herein. The means may be embodied in the form of one or more hardware modules and/or one or more software modules. The term “module” may thus refer to a circuit, a software block or the like according to various embodiments as described below.

The managing module 110 may further comprise a memory 402. The memory may comprise, such as contain or store, instructions, e.g. in the form of a computer program 403, which may comprise computer readable code units.

According to some embodiments herein, the managing module 110 and/or the processing module 401 comprises a processing circuit 404 as an exemplifying hardware module, which may comprise one or more processors. Accordingly, the processing module 401 may be embodied in the form of, or ‘realized by’, the processing circuit 404. The instructions may be executable by the processing circuit 404, whereby the managing module 110 is operative to perform the methods of FIG. 2 and/or FIG. 3. As another example, the instructions, when executed by the managing module 110 and/or the processing circuit 404, may cause the managing module 110 to perform the method according to FIG. 2 and/or FIG. 3.

In view of the above, in one example, there is provided a managing module 110 for managing an escrow payment service for purchases in a store of a vendor. Again, the memory 402 contains the instructions executable by said processing circuit 404 whereby the managing module 110 is operative for:
receiving, directly or indirectly from a server 111, purchase information comprising an identity of the vendor, an identity of a customer, a price, an offer specification and a condition for triggering of transaction advancement,
storing the identity of the vendor, the identity of the customer, the price and the offer specification in a database 150, wherein the identity of the vendor and the identity of the customer are associated with a respective number for anonymizing the vendor and the customer,
storing the respective number of the vendor and the customer and the condition in a smart contract on a blockchain 130,
sending a request for acceptance of the smart contract to the user device 120 of the customer,
receiving, from the user device 120, a response for accepting the smart contract, wherein the response comprises payment information for withdrawing the price from assets of the customer,
setting a state of the smart contract to accepted,
sending, to a payment service provider 118, a transaction request comprising the payment information for ordering a transaction for transfer of funds corresponding to the price to a temporary credit card, wherein the transaction is identified by a transaction identity,
storing the transaction identity in the smart contract,
receiving a transaction response indicating that the temporary credit card holds the funds corresponding to the price,
storing, in the smart contract, an indication of that the transaction according to the transaction identity is completed,
sending, to the server 111 and the user device 120, a notification confirming successful payment and login details for access to list of transactions of the smart contract,
checking the conditions of the smart contract to obtain an answer indicating fulfilment or non-fulfilment of the conditions, and
setting the state of the smart contract to completed or rejected based on the answer, thereby causing the payment to be transferred to the vendor and/or the customer, respectively.

FIG. 4 further illustrates a carrier 405, or program carrier, which provides, such as comprises, mediates, supplies and the like, the computer program 403 as described directly above. The carrier 405 may be one of an electronic signal, an optical signal, a radio signal and a computer readable medium.

In some embodiments, the managing module 110 and/or the processing module 401 may comprise one or more of a receiving module 410, a storing module 420, a sending module 430, a setting module 440, and a checking module 450 as exemplifying hardware modules. The term “module” may refer to a circuit when the term “module” refers to a hardware unit. In other examples, one or more of the aforementioned exemplifying hardware modules may be implemented as one or more software modules.

Moreover, the managing module 110 and/or the processing module 401 may comprise an Input/Output unit 406, which may be exemplified by the receiving module and/or the sending module when applicable.

Accordingly, the managing module 110 is configured for managing an escrow payment service for purchases in a store of a vendor.

Therefore, according to the various embodiments described above, the managing module 110 and/or the processing module 401 and/or the receiving module 410 is configured for receiving, directly or indirectly from a server 111, purchase information comprising an identity of the vendor, an identity of a customer, a price, an offer specification and a condition for triggering of transaction advancement.

The managing module 110 and/or the processing module 401 and/or the storing module 420 is configured for storing the identity of the vendor, the identity of the customer, the price and the offer specification in a database 150. The identity of the vendor and the identity of the customer are associated with a respective number for anonymizing the vendor and the customer.

The managing module 110 and/or the processing module 401 and/or the storing module 420, or another storing module, is configured for storing the respective number of the vendor and the customer and the condition in a smart contract on a blockchain 130.

The managing module 110 and/or the processing module 401 and/or the sending module 430 is configured for sending a request for acceptance of the smart contract to the user device 120 of the customer.

The managing module 110 and/or the processing module 401 and/or the receiving module 410, or another receiving module, is configured for receiving, from the user device 120, a response for accepting the smart contract. The response comprises payment information for withdrawing the price from assets of the customer.

The managing module 110 and/or the processing module 401 and/or the setting module 440 is configured for setting a state of the smart contract to accepted.

The managing module 110 and/or the processing module 401 and/or the sending module 430, or another sending module, is configured for sending, to a payment service provider 118, a transaction request comprising the payment information for ordering a transaction for transfer of funds corresponding to the price to a temporary credit card. The transaction is identified by a transaction identity.

The managing module 110 and/or the processing module 401 and/or the storing module 420, or another storing module, is configured for storing the transaction identity in the smart contract.

The managing module 110 and/or the processing module 401 and/or the receiving module 410, or another receiving module, is configured for receiving a transaction response indicating that the temporary credit card holds the funds corresponding to the price.

The managing module 110 and/or the processing module 401 and/or the storing module 420, or another storing module, is configured for storing, in the smart contract, an indication of that the transaction according to the transaction identity is completed.

The managing module 110 and/or the processing module 401 and/or the sending module 430, or another sending module, is configured for sending, to the server 111 and the user device 120, a notification confirming successful payment and login details for access to list of transactions of the smart contract.

The managing module 110 and/or the processing module 401 and/or the checking module 450 is configured for checking the conditions of the smart contract to obtain an answer indicating fulfilment or non-fulfilment of the conditions.

The managing module 110 and/or the processing module 401 and/or the setting module 440, or another setting module, is configured for setting the state of the smart contract to completed or rejected based on the answer, thereby causing the payment to be transferred to the vendor and/or the customer, respectively.

Even though embodiments of the various aspects have been described, many different alterations, modifications and the like thereof will become apparent for those skilled in the art. The described embodiments are therefore not intended to limit the scope of the present disclosure.

1. A method, performed by a managing module (110), for managing an escrow payment service for purchases in a store of a vendor, wherein the method comprises:
receiving (A020), directly or indirectly from a server (111), purchase information comprising an identity of the vendor, an identity of a customer, a price, an offer specification and a condition for triggering of transaction advancement,
storing (A025) the identity of the vendor, the identity of the customer, the price and the offer specification in a database (150), wherein the identity of the vendor and the identity of the customer are associated with a respective number for anonymizing the vendor and the customer,
storing (A027) the respective number of the vendor and the customer and the condition in a smart contract on a blockchain (130),
sending (A030) a request for acceptance of the smart contract to the user device (120) of the customer,
receiving (A060), from the user device (120), a response for accepting the smart contract, wherein the response comprises payment information for withdrawing the price from assets of the customer,
setting (A070) a state of the smart contract to accepted,
sending (A080), to a payment service provider (118), a transaction request comprising the payment information for ordering a transaction for transfer of funds corresponding to the price to a temporary credit card, wherein the transaction is identified by a transaction identity,
storing (A085) the transaction identity in the smart contract,
receiving (A090) a transaction response indicating that the temporary credit card holds the funds corresponding to the price,
storing (A100), in the smart contract, an indication of that the transaction according to the transaction identity is completed,
sending (A110), to the server (111) and the user device (120), a notification confirming successful payment and login details for access to list of transactions of the smart contract,
checking (A120) the conditions of the smart contract to obtain an answer indicating fulfilment or non-fulfilment of the conditions, and
setting (A130) the state of the smart contract to completed or rejected based on the answer, thereby causing the payment to be transferred to the vendor and/or the customer, respectively.

2. A managing module (110) configured for managing an escrow payment service for purchases in a store of a vendor, wherein the managing module (110) is configured for:
receiving, directly or indirectly from a server (111), purchase information comprising an identity of the vendor, an identity of a customer, a price, an offer specification and a condition for triggering of transaction advancement,
storing the identity of the vendor, the identity of the customer, the price and the offer specification in a database (150), wherein the identity of the vendor and the identity of the customer are associated with a respective number for anonymizing the vendor and the customer,
storing the respective number of the vendor and the customer and the condition in a smart contract on a blockchain (130),
sending a request for acceptance of the smart contract to the user device (120) of the customer,
receiving, from the user device (120), a response for accepting the smart contract, wherein the response comprises payment information for withdrawing the price from assets of the customer,
setting a state of the smart contract to accepted,
sending, to a payment service provider (118), a transaction request comprising the payment information for ordering a transaction for transfer of funds corresponding to the price to a temporary credit card, wherein the transaction is identified by a transaction identity,
storing the transaction identity in the smart contract,
receiving a transaction response indicating that the temporary credit card holds the funds corresponding to the price,
storing, in the smart contract, an indication of that the transaction according to the transaction identity is completed,
sending, to the server (111) and the user device (120), a notification confirming successful payment and login details for access to list of transactions of the smart contract,
checking the conditions of the smart contract to obtain an answer indicating fulfilment or non-fulfilment of the conditions, and
setting the state of the smart contract to completed or rejected based on the answer, thereby causing the payment to be transferred to the vendor and/or the customer, respectively.

3. A management module (110) configured to perform the method according to claim 1.

4. A computer program (403), comprising computer readable code units which when executed on a managing module (110) cause the managing module (110) to perform the method according to claim 1.

5. A carrier (405) comprising the computer program according to claim 4, wherein the carrier (405) is one of an electronic signal, an optical signal, a radio signal or a computer readable medium.
